(19) United States
(12) Patent Application Publication
(10) Pub. No.: US 2021/0368757 A1
(43) Pub. Date: Dec. 2, 2021

(54) FEARLESS FISHING LURE DEFLECTOR

(71) Applicant: Charles Antetomaso, Merritt Island, FL (US)

(72) Inventor: Charles Antetomaso, Merritt Island, FL (US)

(21) Appl. No.: 16/890,939

(22) Filed: Jun. 2, 2020

(51) Int. Cl. A01K 85/02

(52) U.S. Cl. CPC A01K 85/02

(57) ABSTRACT

An article of manufacture for providing fishing equipment, and more specifically, an article of manufacture which provides a deflector that protects fishing lures from underwater obstacles is disclosed.

### TECHNICAL FIELD

This application relates in general relates to an article of manufacture for providing fishing equipment, and more specifically, to an article of manufacture which provides a deflector that protects fishing lures from underwater obstacles.

### BACKGROUND

People who fish often encounter unseen underwater obstacles that become a problem for lures and other hardware when they become entangled with these obstacles. These underwater obstacles may include rocks, grasses and other underwater plants, and man-made items discarded into the water. Devices such as “hook guards” and “weed guards” have been around for decades, as have numerous wire configurations for spinnerbaits and a “squarebill” lip for crankbaits. None of these devices, however, is foolproof in preventing lures, hooks, and fishing lines from becoming entangled with underwater obstacles.

Therefore, a need exists for a simple, inexpensive and effective mechanism to prevent fishing lures and related items from fouling with underwater objects. These “deflectors” must be integrated into lure designs as well as added to a fishing line that uses existing lures. The present invention as disclosed herein addresses the shortcomings of existing solutions.

### SUMMARY

In accordance with the present invention, the above and other problems are solved by an article of manufacture which provides a deflector that protects fishing lures from underwater obstacles according to the principles and example embodiments disclosed herein.

In one embodiment, the present invention is an article of manufacture for providing fishing equipment, and more specifically, an article of manufacture for providing a deflector that protects fishing lures from underwater obstacles.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It also should be realized by those skilled in the art that such equivalent constructions do not depart from the spirit and scope of the invention as set forth in the appended claims. The novel features that are believed to be characteristic of the invention, both as to its design and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment of an article of manufacture that protects fishing lures from underwater obstacles external to the lures according to the present invention.

FIG. 2 illustrates an example embodiment of an article of manufacture for protecting fishing lures from underwater obstacles internal to the lures according to the present invention.

FIG. 3 illustrates an example embodiment of an article of manufacture that protects fishing lures from underwater obstacles both internal and external to the lures according to the present invention.

FIGS. 4a-c illustrate various embodiments of an article of manufacture for protecting fishing lures from underwater obstacles external to the lures according to the present invention.

FIGS. 5a-b illustrate various embodiments of an article of manufacture that protects fishing lures from underwater obstacles internal to the lures according to the present invention.

### DETAILED DESCRIPTION

This application relates in general to an article of manufacture that provides fishing equipment, and more specifically, to an article of manufacture for protecting fishing lures from underwater obstacles.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a lure” includes reference to one or more of such lures and “coupling” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly,” consistent with the discussion above regarding ranges and numerical data.

The terms “customer,” “fisherman,” and “user” refer to an entity, e.g. a human, using the Fearless Fishing Lure Deflector. The term user herein refers to one or more users.

The term “invention” or “present invention” refers to the invention being applied for via the patent application titled “Fearless Fishing Lure Deflector.” Invention may be used interchangeably with deflector.

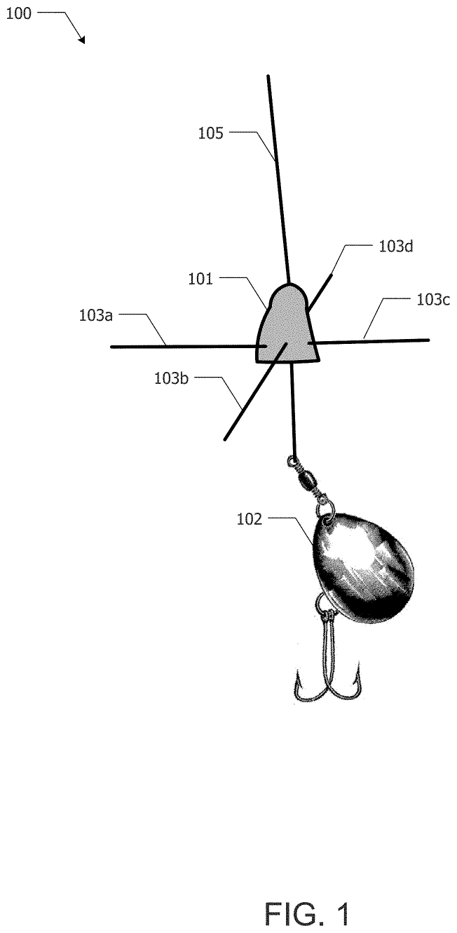

In general, the present disclosure relates to an article of manufacture that protects fishing lures from underwater obstacles according to the present invention. To better understand the present invention, FIG. 1 illustrates an example embodiment for an article of manufacture for protecting fishing lures from underwater obstacles external to the lures according to the present invention. A fishing lure 102 is attached to a fishing line 105 with an external fishing lure deflector 100 attached thereto. The external fishing lure deflector 100 is coupled to the fishing line a few inches up the line from the lure 102. The addition of items of the type disclosed herein that are specifically added to lures to act as one or more defectors is not known in the prior art. While some shapes that have been part of various lure shapes may assist in reducing likelihood of a particular lure from snagging on an underwater obstacle, a specific lure defector made through clever wire-shapes/designs, while developed for the purpose of getting through more types of obstacles than lures with dangling hooks, even those lures can benefit greatly from the addition of internal, external deflectors or both.

The external fishing lure deflector 100 comprises a central deflection object that has a conical-shaped center body 101 and a plurality of semi-rigid deflecting arms 103a-d extending outward from the center body 101, generally being equally spaced about the circumference of the center body. The center body 101 itself has a width slightly wider than the lure while it may be of varying sizes.

The plurality of semi-rigid deflecting arms 102a-d extend outward, being wide enough to deflect obstacles away from the lure as it passes by so that the obstacle does not return to its original orientation until the lure 102 has passed. The plurality of semi-rigid deflecting arms 103a-d may be constructed using wire and rigid synthetic materials. The semi-rigid deflecting arms 103a-d are sufficiently rigid to deflecting the fishing rigs motion travelling under the water away from obstacles encountered along the path of a fishing rig and fishing lure.

An external deflector 100, having a hole in the center of the material, is able to slide on the line. A preferred placement would be to place the external deflector 100 as close to the lure as possible which is typically above the knot tied to the lure. Additionally, a preferred embodiment may secure the external deflector 100 by using a “bobber stop” 101 or similar such component readily available in the marketplace. The bobber stopper 101 is component which prevents attached components from separating themselves from optimal placement in front of the lure.

An external deflector 100 may be able to be used interchangeably by the fisherman with many lures on any one of many rod/reels setups. The size/length of external deflector arms/legs 103a-d may be as short as ½ inch to a preferred maximum length of two inches. Because the external deflector 100 is located far enough in front of the hook(s) of the lure, external deflectors, do not pose a hindrance to the fish's ability to engulf the lure and/or to get successfully hooked.

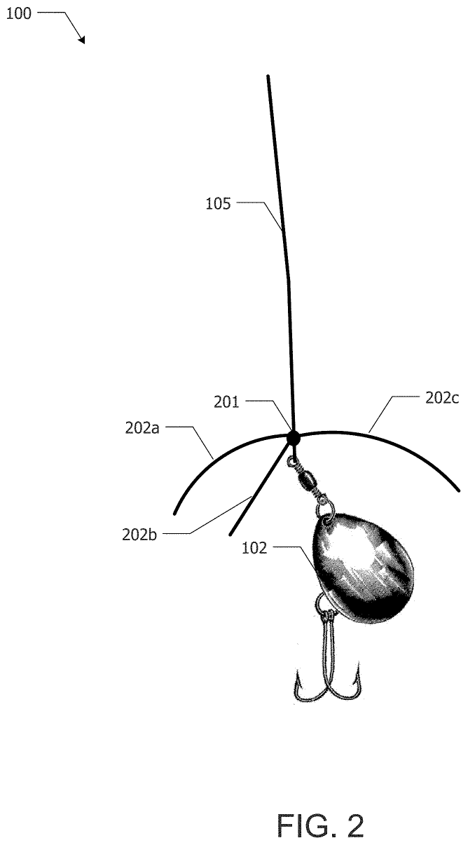

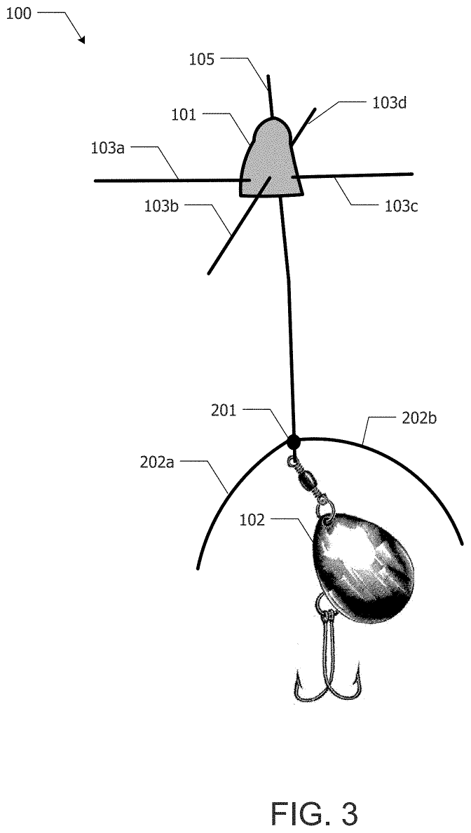

While the bobber stopper 101 may be conical-shaped as shown in FIG. 1 this shape may provide ant efficient shape of an external deflector 100. However, a simple design, as shown in FIGS. 2-3, would entail the least amount of material comprising the “hub,” or a simple collar, from which the “arms” or “legs” (deflectors) 103a-d would protrude. As noted above, the external deflector 100 may be constructed in varying strengths/stiffnesses and lengths. These parameters may be decided by trial and error and by user-preference, once the user becomes familiar with the product. Further, these parameters may also vary, depending on the “mass” of the obstacle (i.e. grass, wood, rock, etc.).

In contrast to external deflectors, an internal deflector s attached to, or built into, the lure, an may vary from lure to lure. For example, since the primary material/configuration of “spinnerbaits” and “buzzbaits” is comprised of various bent wire formations, one embodiment may use material to “add” for the deflector consisting of the same material, either crimped, soldered or perhaps even built into an original design. An example embodiment may be a concept using simple lengths of wire protruding outward. However, less line “entanglements” may be experienced by “closing” the “loop”. For example, a spinnerbait where the wire arcs from one attachment point to another, thus reducing the possibility of line “wrapping” or “entanglement.”

Similarly, the positioning of adequate deflectors on spinnerbaits and buzzbaits, do not hinder the successful “hook-up” ratio for the user. However, as for other styles of lures, the smaller the lure, or the closer in proximity to the hooks that the deflector is, “hook-up” ability could be affected.

FIG. 2 illustrates an example embodiment of an article of manufacture that protects fishing lures from underwater obstacles internal to the lures according to the present invention. In this embodiment, the fishing lure 102 is coupled to the fishing line 105 in an ordinary manner. As stated previously, many materials are possible and available for use, ranging from various metals to plastics to other synthetics. While for “external” use, I believe the optimum, most commonly adopted material, will be of the plastic/synthetic variety. However, the need for additional “weight” may be desirable in some situations (as I myself discovered). Therefore, the “hub” of the external deflector would be “denser”, accomplished by choice of material. I modified a common traditional lead “bullet weight” by drilling and inserting wire material through the hub, thus forming the “arms” or “legs”. The optimum “bend” or “angle” (and length) of protrusion, again, will be easily discovered, and adjustable, by the user and, as such, will be a matter of personal preference, according to the nature of the obstacle, for which the device is to deflect from.

A small connection point is made to the end of the fishing lure 102 near the eyehook of the lure. A plurality of deflection arms 201a-c extend from the connection point outward and may be curved backward toward the far end of the lure 102. The curvature of the deflection arms 202a-c needs to be less than an amount that prevents a fish from attempting to swallow the lure 102. The number of deflection arms 202a-c may vary and generally are arranged around the entire area of the lure 102.

FIG. 3 illustrates an example embodiment of an article of manufacture for protecting fishing lures from underwater obstacles both internal and external to the lures according to the present invention. The fishing lure deflectors may utilize both the external-type of FIG. 1 with the internal-type of FIG. 2 so that they work together to protect the lure 102 from fouling. Once again various numbers of deflection arms 102a-d, 301a-b may be used.

The number of protruding arms 103a-d may depend upon user preference. Traditional thinking might suggest that “more is better”. In a preferred embodiment, a minimum effective number is three (3) arms. No maximum is recommended or suggested. However, pure physics will determine the best number, based on materials chosen for manufacture. For example, the thinner the material that can be used, the more protrusions might be possible, without adversely affecting the performance of the lure.

As mentioned above, the method of attachment or built-in accommodation of the deflector technology, into/onto a lure may include many possibilities. The external deflector technology will be the simplest to develop/employ. Internal design considerations will be more complex. Again, whether deflectors are built into the lures or whether the lures will be modified, via receivers, such as threaded receptacles, glue-in holes, and the like. may be a design consideration of a manufacturer.

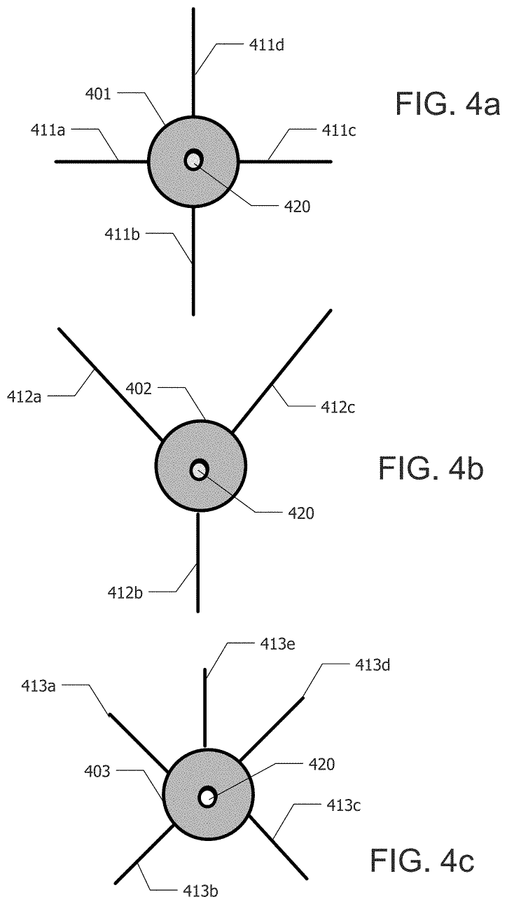

FIGS. 4a-c illustrate various embodiments of an article of manufacture for protecting fishing lures from underwater obstacles external to the lures according to the present invention. In these figures, the external deflectors 401-403 are shown with differing numbers of deflection arms. FIG. 4a has an external deflector 401 with 4 evenly spaced deflection arms 411a-d. FIG. 4b has an external deflector 402 with 3 evenly spaced deflection arms 412a-c. FIG. 4c has an external deflector 403 with 5 evenly spaced deflection arms 413a-e.

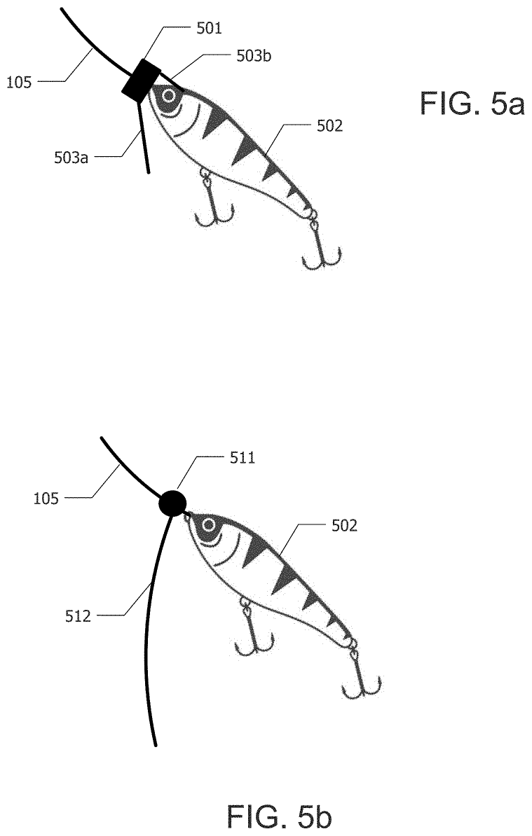

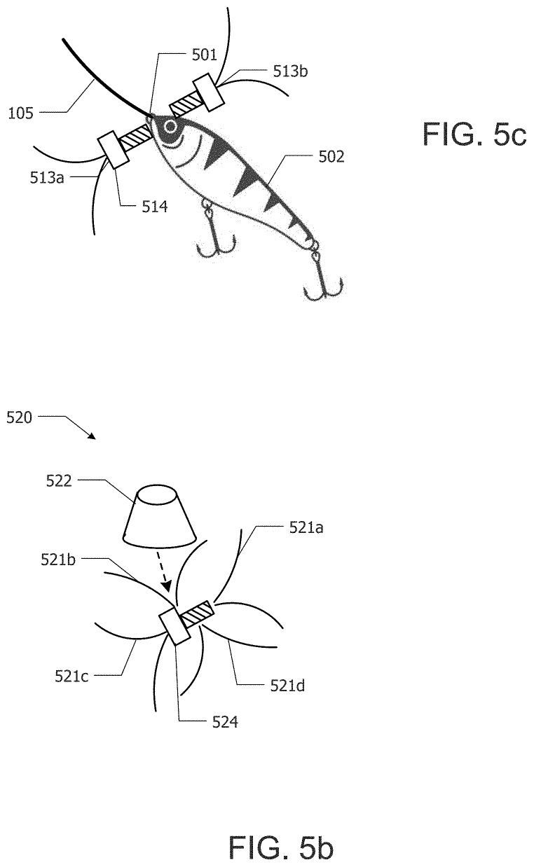

FIGS. 5a-d illustrate various embodiments of an article of manufacture that protects fishing lures from underwater obstacles internal to the lures according to the present invention. In these embodiments the fishing lure 502 appears as a swimming fish moving horizontally through the water. In the first embodiment of FIG. 5a, a small platform 501 is attached in a horizontal direction. A pair of deflecting arms 503a-b are coupled to the underside surface of the platform 501 and is arranged to point downward from the opposite edges of the platform. Because the lure 502 is expected to be oriented in a particular direction, the deflection arms 503a-b protect the lure from obstacles on the bottom of the body of water.

In the second embodiment of FIG. 5b, a single deflection arm 512 is attached to the front end of the lure 502 at a connection point 511. Once again, the directional nature of the lure 502 permits the deflection arm 512 to be attached only to the underside of the lure 502. As noted above, the deflection arm 512 may curve backward toward the rear of the lure 502 and extend outward. The amount the deflection arm 512 curves must permit the fish to strike the lure 502 inside the curvature of the deflection arm 512.

A “snap on” method of attachment may be preferred. For some lures, deflectors may also be attached via molded self-crimping or self-grabbing crevices or slots, similar to the way a pen may be attached to a shirt pocket holder. The deflectors may be attached by a manufacturer or attached to the lure by an end-user. In either case, the deflector may be potentially removable, by simply un-crimping it from the lure and potentially crimping it on to another lure

FIG. 5c illustrates use of a threaded base, as an attachment method for both deflectors and weed-guards. FIG. 5c illustrates the placement of deflectors [single or “V” (shown)] on the side of a lure. Therefore Images 1 & 2 illustrate that multiple “receivers” can be built into a lure to facilitate accessory add-ons, in this case deflectors. Unused receivers should not affect the lure's performance in any appreciable negative way. They could also be “closed” with little screw in “covers”, which in itself, represents a new product line. Such covers could be used to imitate “eyes” on the lure or simply to add color or flash.

FIG. 5c illustrates the placement of the threaded “V”-style deflector/weed-guard on a lure 502, specifically a “chatter-bait” and would be similar on a “spinner-bait” or “buzz-bait”. The hook would ride between the two protruding arms. This concept allows everyone to benefit from the use of deflector/weed-guards easily without the need for special skills or the possibility of damaging the lure 502. Other embodiments may include potential placement of a threaded deflector 514, either a single, “V,” or two single arms. Another possible placement is on the lip of the lure as shown in FIGS. 5a-b.

FIG. 5c portrays a “V”-style device 513a-b which may be used as either a deflector or weed-guard, depending on where it is placed on a lure 502. A single strand deflector (not shown) would have a similar base. The use of the bolt 514 in the illustration merely portrays where the base would be on the device. The actual threaded base may be much smaller and would be created within the “mold” used in a manufacturing process of the lure 502.

FIG. 5d illustrates one possible configuration of an external deflector 520, using four sets of “V”-style deflectors 521a-d, with or without a threaded base 524. The central hub 522 may be more refined and matched aesthetically and functionally to the material used. Hubs/legs may be threaded or simply one-piece molded. Heavier denser material may also be used to add more weight, which may be relevant and practical, depending on the situational fishing preference.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations.

No element, act or instruction used in the present application should be construed as critical or essential to the invention unless explicitly described as such. Further, the phrase “based on” is intended to mean “based, at least in part, on” unless explicitly stated otherwise.

What is claimed:

1. An article of manufacture for providing fishing equipment, and more specifically, an article of manufacture which provides a deflector that protects fishing rigs having at least one fish hook and an attached fishing line from snagging upon underwater obstacles, the article of manufacture comprising:
one or more semi-rigid deflecting arms added to a fishing rig for defecting underwater obstacles as the rig passes through the water. the one or more semi-rigid deflecting arms extend outward from the fishing rig in different directions relative to the fishing lie; and
coupling device for adding the one or more semi-rigid deflecting arms to the fishing rig;
wherein the semi-rigid members are sufficiently rigid to deflecting the fishing rigs motion travelling under the water away from obstacles encountered along the path of the fishing rig.

2. The article of manufacture according to claim 1, wherein the fishing rig corresponds to a fishing lure attached to the fishing line.

3. The article of manufacture according to claim 2, wherein the one or more semi-rigid deflecting arms are coupled to the fishing lure.

4. The article of manufacture according to claim 3, wherein coupling device comprises a threaded screw matching a threaded hole in the fishing lure.

5. The article of manufacture according to claim 3, wherein the coupling device is an enclosed capture device having an inner shape matching a corresponding attachment point on the fishing lure such that the enclosed capture device restrains the coupling device to the fishing lure.

6. The article of manufacture according to claim 2, wherein the coupling device and the one or more semi-rigid deflecting arms are a single strand of wire threaded around a location on the fishing lure and extending outward.

7. The article of manufacture according to claim 3, wherein the coupling device attached the one or more semi-rigid deflecting arms to the fishing line ahead of the fishing lure.

8. The article of manufacture according to claim 7, wherein the one or more semi-rigid deflecting arms extend of a central deflection object coupled directly to the fishing line.

9. The article of manufacture according to claim 8, wherein the one or more semi-rigid deflecting arms comprises at least 3 deflecting arms.

10. The article of manufacture according to claim 2, wherein the one or more semi-rigid deflecting arms comprises at least 3 deflecting arms.
